(19) United States
(12) Patent Application Publication
(10) Pub. No.: US 2015/0360987 A1
(43) Pub. Date: Dec. 17, 2015

(54) REACTOR WITH ANTIMICROBIAL MEDIUM FOR LIQUID DISINFECTION

(71) Applicant: SONITEC-VORTISAND TECHNOLOGIES INC., St-Laurent (CA)

(72) Inventors: Marco BOSISIO, Sherbrooke (CA); Alain SILVERWOOD, St-Eustache (CA)

(21) Appl. No.: 14/762,839

(22) PCT Filed: Jan. 24, 2014
(86) PCT No.: PCT/CA2014/050054

§ 371 Date: Jul. 23, 2015

Related U.S. Application Data
(60) Provisional application No. 61/756,199, filed on Jan. 24, 2013.

(51) Int. Cl. C02F 9/00; C02F 1/42; C02F 1/28; C02F 1/50; C02F 1/44

(52) U.S. Cl. CPC C02F 9/00; C02F 1/50; C02F 1/44; C02F 1/281; C02F 1/42; C02F 2303/04

(57) ABSTRACT

It has been discovered that providing a reactor for disinfecting liquids having therein an antimicrobial-coated medium in an active and dynamic suspension allows for the passage of certain particles while preventing the passage of viable microorganisms. There is provided a reactor for disinfecting a liquid comprising a raw liquid inlet for allowing a raw liquid to enter the reactor, a disinfected liquid outlet for releasing a disinfected liquid from the reactor, and a suspension device for creating a highly dynamic suspension of the antimicrobial medium in a cross-section of the reactor through which the raw liquid passes to insure a substantially uniform, high average number of interactions between the antimicrobial medium and microorganisms present in the liquid passing through the reactor, thereby decreasing a quantity of viable microorganisms in the liquid as it passes from the inlet to the outlet.

This application claims priority to U.S. Provisional Application No. 61/756,199 filed Jan. 24, 2013.

### FIELD OF THE INVENTION

The subject matter disclosed generally relates to reactors for liquid disinfection. The subject matter disclosed relates more specifically to organosilane coated particles for liquid disinfection.

### BACKGROUND OF THE INVENTION

An ever increasing environmental concern associated with harmful bacteria, and more particularly, with harmful bacteria in water environments, has recently been observed.

For example, E. Coli is a widely recognized health risk and Legionella pneumophila is a known pathogen associated with cooling towers. The most common sources of Legionella and Legionnaires' disease outbreaks are cooling towers (i.e., used in industrial cooling water systems), domestic hot water systems, and spas. Additional sources include large central air conditioning systems, fountains, domestic cold water, swimming pools (i.e., especially in Scandinavian countries and northern Ireland) and similar disseminators that draw upon a public water supply. Natural sources include freshwater ponds and creeks. Many governmental agencies, hospitals, long term health care facilities, retirement homes, cooling tower manufacturers, and industrial trade organizations have developed design and maintenance guidelines for preventing or controlling the growth of Legionella in cooling towers, but also in hot pressure systems. More particularly, in retirement homes, the growth of Legionella may be accelerated since the water needed from the hot water systems must be at a lower temperature for well being of an elderly person.

Peterson et al. (U.S. patent application Ser. No. 10/820,121) and Williamson et al. (U.S. patent application Ser. No. 11/593,750) teach filters using solid phase carriers coated with quaternary ammonium organosilane coatings to reduce viable microorganisms as liquid passes through the filter. In these two applications, the coated filtering medium is effectively “immobilized” or “stationary” in order to form an efficient filtering barrier.

### SUMMARY OF THE INVENTION

It has been discovered that providing a reactor for liquid disinfection having an antimicrobial-coated medium therein that is not immobilized in a filter but rather in an active and dynamic suspension in the reactor allows for the passage of certain particles while preventing the passage of viable microorganisms/microbes.

According to an embodiment, there is provided a reactor for disinfecting a liquid comprising, a raw liquid inlet for allowing a raw liquid to enter the reactor; a disinfected liquid outlet for releasing a disinfected liquid from the reactor; and a suspension device for creating a highly dynamic suspension of an antimicrobial medium in a cross-section of the reactor through which the raw liquid passes to insure a substantially uniform, high average number of interactions between the antimicrobial medium and microorganisms present in the liquid passing through the reactor, thereby decreasing a quantity of viable microorganisms in the liquid as it passes from the inlet to the outlet. In such an embodiment a microorganism in the liquid passing through a channel of the antimicrobial suspension will make an average number of efficient contacts (i.e. killing contacts) with the antimicrobial medium that is uniform for all possible channels in the reactor.

According to another embodiment, there is provided an inlet nozzle connected to the raw liquid inlet, the nozzle being located below the disinfected liquid outlet, such that an upstream flow in the reactor causes the antimicrobial medium to be in suspension in the reactor during operation. It will be appreciated that the predetermined upstream flow rate required to provide an appropriate level of suspension (expansion) of the particles is a function of many parameters such as the density, the expandability, the sphericity and roundness of the particles to be put into suspension.

According to yet an embodiment, the suspension device comprises an agitator in the reactor, wherein in operation, the agitator agitates the antimicrobial medium and the raw liquid entering into the reactor. The suspension device can also comprise an air inlet for injecting an air stream into the reactor, thereby allowing the antimicrobial medium to be in suspension in the reactor during operation. It will be appreciated that the air inlet can be used either alone or in conjunction with other suspension devices in order to provide the appropriate level of expansion of the antimicrobial medium.

According to still an embodiment, there is provided a filtering device for separating the antimicrobial medium from the liquid. The filtering device can comprise, for example, a nylon membrane and/or a wedgewire to prevent the outflow of antimicrobial medium from the reactor.

According to an embodiment, there is provided a media coated with an antimicrobial compound. The media can comprise one or any combination of sand particles, anthracite, gravel, activated carbon, zeolite, clay, diatomaceous earth, garnet, ilmenite, zircon, charcoal, ion exchange resin, silica gel, titania, black carbon, PVC, glass, glass, polymeric particles, plastic particles, organic particles. The media can comprise sand particles having an average particle size between 0.01 mm and 1.0 mm. The media preferably comprise sand particles having an average particle size of approximately 0.15 mm.

According to another embodiment, there is provided an antimicrobial compound comprising one or any combination of a zero-valent metal compound, an iron compound, a cast iron compound, a high purity iron compound, an iron sponge compound, iron powder, an aluminum compound, a ferrous sulfate compound, a ferric chloride compound, an aluminum sulfate compound, a quaternary ammonium salt compound, a quaternary ammonium compound, an oxidizing agent, a chelating agent, a surfactant, a wetting agent, an antibiotic compound, an antifungal agent, an antiviral agent, a silver compound, a copper compound, a zinc compound, a zero-valent silver compound, a zero-valent copper compound, a zero-valent zinc compound, a copper sulfate compound.

According to a preferred embodiment, the antimicrobial compound can comprise octadecyldimethyl(trimethoxysilylpropyl) ammonium chloride.

According to yet another embodiment, the antimicrobial medium can comprise media coated with a concentration of antimicrobial compound between 0.1 to 1000 moles of compound per kilogram of media but preferably approximately 15 moles of compound per kilogram of media.

According to still another embodiment, the antimicrobial medium is able to resist (maintain its antimicrobial activity) to a 20 hour 0.1% bleach pre-treatment.

According to an embodiment, the antimicrobial medium is effective at killing the bacterial strains E. coli ATCC8739, E. coli O157:H7 EDL933 (the strain known to cause Hamburger disease) and Legionella pneumophila (often found in cooling towers).

According to another embodiment, a base is configured to support the reactor such that a longitudinal axis of the reactor is either horizontal or vertical. According to yet another embodiment, a shape of the reactor can be a conical shape, a cylindrical shape, a square shape, a polygonal shape, a spherical shape.

According to still another embodiment, there is provided a secondary tank for allowing a separation between the antimicrobial medium and the disinfected liquid flow. In such an embodiment, a secondary antimicrobial medium inlet allows a separated antimicrobial medium to re-enter the reactor.

According to an embodiment, bearings can be provided for rotating the reactor such that, in operation, the reactor rotates about its longitudinal axis, allowing the antimicrobial medium to be put into suspension in the reactor.

According to another embodiment, the is provided a reactor comprising a plurality of compartments for receiving the antimicrobial medium therein.

According to yet another embodiment, the suspension device causes an expansion of the antimicrobial medium by between 10% and 80% as compared to when the suspension device is inactive. According to a preferred embodiment, the antimicrobial medium is expanded by approximately 50% as compared to when the suspension device is inactive.

According to still another embodiment, a flow rate of approximately 15 m³ of liquid per m² of surface area per hour entering the reactor maintains a 50% expansion of the antimicrobial medium of inside the reactor as compared to when there is an absence of flow.

According to an embodiment, a flow sensor and an expansion sensor is provided for triggering at least one of an alarm and a flow adjustor when a detected flow rate or a level of expansion of the antimicrobial medium is outside of a predetermined range for creating a level of expansion of the antimicrobial medium inside the reactor.

According to another embodiment, a cooling tower is combined with a reactor according to the present invention and the liquid is liquid from the cooling tower.

According to an embodiment, there is provided a method of disinfecting a liquid containing microorganisms comprising, providing a reactor having a liquid inlet, a liquid outlet, and an antimicrobial medium therein; receiving the liquid from the liquid inlet; creating a highly dynamic suspension of the antimicrobial medium in a cross-section of the reactor, thereby causing a high average number of interactions between the microorganisms and the antimicrobial medium and decreasing a quantity of viable microorganisms as the liquid passes from the inlet to the liquid outlet; and releasing from the liquid outlet a disinfected liquid separated from the antimicrobial medium.

According to an embodiment, it is advantageous to filter the antimicrobial medium from the liquid before releasing it.

According to an embodiment, there is provided a reactor for liquid disinfection comprising: a tank; a raw liquid inlet on the tank for allowing a raw liquid flow to enter the tank; a disinfected liquid outlet on the tank for allowing a disinfected liquid flow to exit the tank; and an antibacterial medium in the tank for contacting and disinfecting the raw liquid flow; wherein when in operation, the antibacterial medium is in suspension in the tank and allows for the disinfected liquid flow exiting the tank to have a lower bacteria concentration than the raw liquid flow entering the tank.

According to another embodiment, the raw liquid inlet is below the disinfected liquid outlet for creating an upstream flow in the tank when the reactor is in operation, thereby allowing the antibacterial medium to be in suspension in the tank.

According to a further embodiment, the reactor further comprises an agitator in the tank, wherein when in operation, the agitator agitates the raw liquid flow entered in the tank and the antibacterial medium. According to yet another embodiment, the antibacterial medium comprises a media coated with an antibacterial compound.

According to yet another embodiment, the tank is one of: a closed tank and an opened tank. According to another embodiment, the tank defines one of: a longitudinal horizontal axis and a longitudinal vertical axis.

According to yet another embodiment, the reactor further comprises an air inlet at the bottom of the tank for allowing an air stream to enter the tank when the reactor is in operation, thereby allowing the antibacterial medium to be in suspension in the tank.

According to a further embodiment, the media can comprise a PVC material, a polyethylene material, a plastic material, a stainless steel material, a steel material, a heat-resistant material, a cold-resistant material and any combination thereof.

According to yet another embodiment, when in operation, the media coated with the antibacterial compound prevents bio-fouling.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 illustrates a reactor with an antimicrobial medium in accordance with an embodiment;

FIG. 2 illustrates a reactor with an antimicrobial medium in accordance with another embodiment;

FIG. 3 illustrates a reactor with an antimicrobial medium in accordance with another embodiment;

FIG. 4 illustrates a reactor with an antimicrobial medium in accordance with another embodiment;

FIG. 5 illustrates a reactor with an antimicrobial medium in accordance with another embodiment;

FIG. 6 illustrates a reactor with an antimicrobial medium in accordance with another embodiment;

FIG. 7 illustrates a reactor with an antimicrobial medium in accordance with another embodiment;

FIG. 8 is a cross sectional view of the reactor of FIG. 7;

FIG. 9 is a graph of bacterial activity as a function of various antimicrobial coatings, highlighting mineral/metal based coatings (FIG. 10A) and organic based coatings (FIG. 10B);

FIG. 10 is a graph of bacterial (E. coli—ATCC8739) activity as a function of various antimicrobial coatings of sand having average particle sizes of 0.5 mm and 0.15 mm;

FIG. 11 is a graph of bacterial activity as a function of various antimicrobial coatings in the presence or absence of bleach pretreatment;

FIG. 12 is a graph of bacterial (E. coli—O157:H7 EDL933) activity as a function of various antimicrobial coatings of sand having average particle sizes of 0.5 mm and 0.15 mm;

FIG. 13 is a graph of bacterial (Legionella pneumophila) activity as a function of various antimicrobial coatings of sand having average particle sizes of 0.5 mm and 0.15 mm;

FIG. 14 is a graph of bacterial (E. coli—ATCC8739) activity as a function of various incubation times (between 5 and 60 minutes) with various antimicrobial-coated sand samples having a 0.5 mm average particle size; and

FIG. 15 is a graph of bacterial (E. coli—O157:H7 EDL933) activity as a function of various incubation times (between 10 seconds and 8 minutes) with antimicrobial-coated sand having a 0.5 mm average particle size.

It will be noted that throughout the appended drawings, like features are identified by like reference numerals.

### DETAILED DESCRIPTION

In embodiments there are disclosed reactors for liquid disinfection and cooling tower for liquid disinfection.

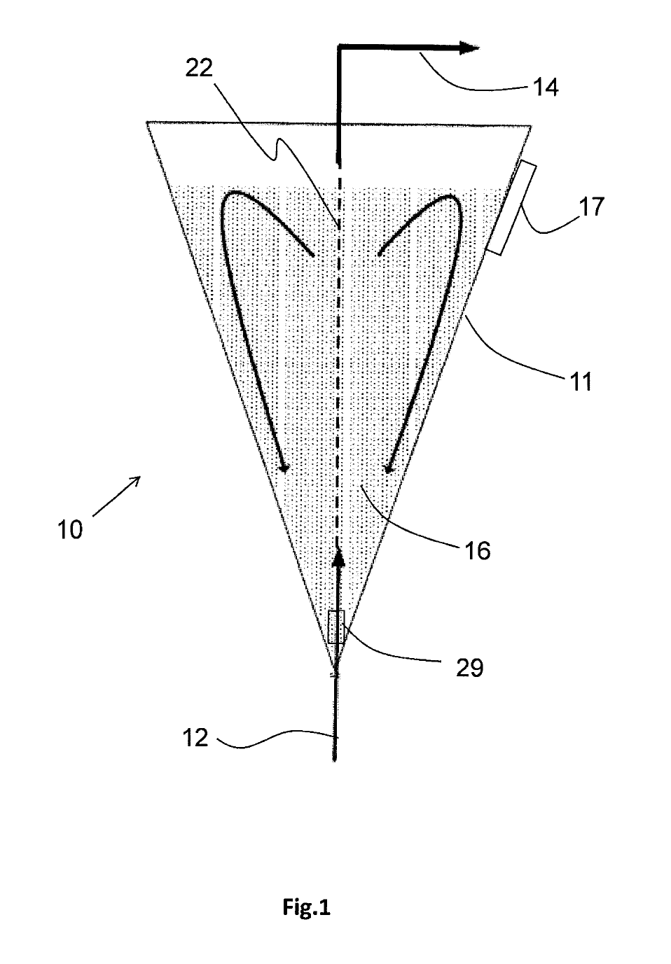

Referring now to the drawings, and more particularly to FIGS. 1-7, there is shown a reactor 10 for liquid disinfection. The reactor 10 includes a tank 11, a raw liquid inlet 12 on the tank 11 which allows a raw liquid flow (not shown) to enter the tank 11 and a disinfected liquid outlet 14 on the tank 11 which allows a disinfected liquid flow (not shown) to exit the tank 11. The reactor 10 further includes an antimicrobial medium 16 in the tank 11 which, in operation of the reactor 10, contacts and disinfects the raw liquid flow 12 which enters the tank 11 through nozzle 29. As shown in FIGS. 1-7, in operation, the antimicrobial medium 16 is in suspension in the tank 11. This configuration of the antimicrobial medium 16 suspended in the tank 11 allows the disinfected liquid flow which exits the tank 11 to have a smaller bacteria concentration than the raw liquid flow which enters the tank 11.

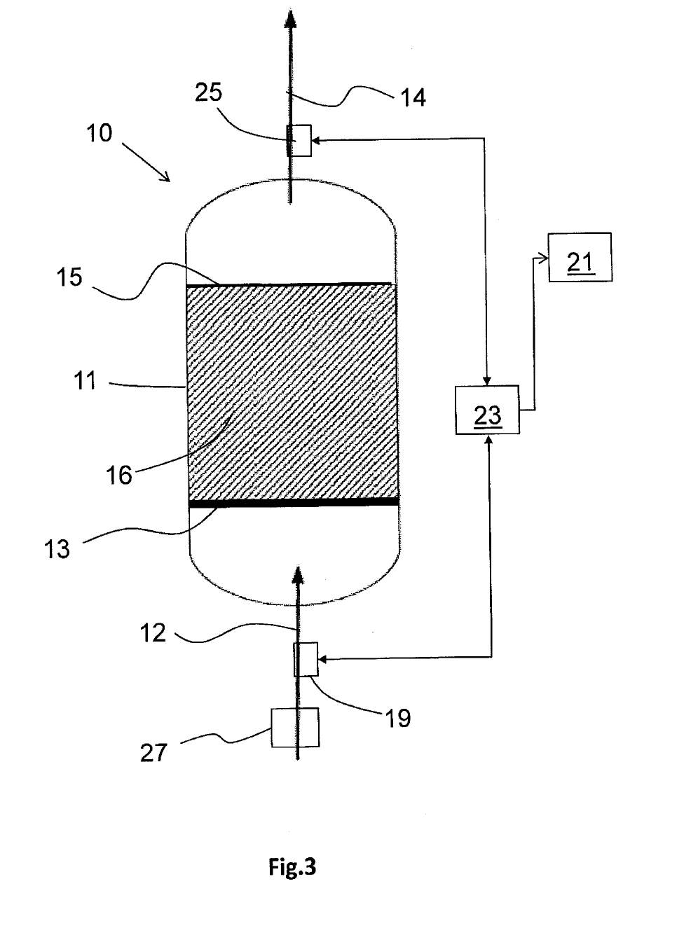

According to an embodiment and referring now to FIGS. 1, 3 and 6, the raw liquid inlet 12 on the tank 11 of the reactor 10 is below the disinfected liquid outlet 14 for creating an upstream flow (not shown) in the tank 11 when the reactor 10 is in operation. This configuration of the raw liquid inlet 12 and disinfected liquid outlet 14 allows the antimicrobial medium 16 to be in suspension in the tank 11 of the reactor 10. In some embodiments such as that shown in FIG. 1, an expansion sensor 17 can detect a level of suspension (expansion) of the antimicrobial medium 16 in the tank. It will be appreciated that, in some cases, controlling a level of expansion of the antimicrobial medium 16 in the reactor 10 can be advantageous for treating specific types of raw liquids. In this case, an expansion sensor 17 detects the level of expansion of the antimicrobial medium 16 in the reactor 10 and, in response, a controller (shown in FIG. 3) can adjust certain parameters in order to return the level of expansion back into the predetermined range of optimal expansion levels. The level of expansion can be detected by various sensors such as a turbidimeter, spectrometer, etc. In some embodiments, an expansion that is outside the predetermined range will trigger an alarm to alert an operator and/or to initiate an automatic corrective response by the controller (e.g. adjusting a valve to control flow rate, adjusting agitator speed). It will be appreciated that an embodiment such as that shown in FIGS. 1,3 and 6 may require a pump 27 (see FIG. 3) for creating the necessary force for upstream flow of the liquid against gravity and against an antimicrobial medium 16. It will also be appreciated that a positive displacement pump can be used to insure sufficient flow rates responsible suspension of the media without thereby requiring sensors/valves to ensure sufficient flow.

In some embodiments, as shown in FIG. 3, a media supporting element 13 is located near a bottom of a tank to receive and support the media present therein. The media supporting element 13 can be combined with a nozzle configured to release a raw liquid at a plurality of locations at the bottom of the tank (not shown) to avoid the creation of preferential current flows (channels) or to favor the full and complete suspension of the media inside the tank. The media supporting device can also be a type of wedgewire™ material that is able to support the media while allowing the passage of raw liquid from the bottom of the tank. In some embodiments, especially embodiments designed for higher flow rates into the tank, a media barrier 15 is placed above the antimicrobial medium 16 to prevent the loss of medium as liquid flows out of the disinfected liquid outlet 14. The media barrier 15 can be a nylon membrane covering a cross-section of the reactor. In other embodiments, the media barrier 15 can be a wedgewire-like material (e.g. made of stainless steel) and the media supporting element 13 can be a nylon membrane. The media barrier 15 and media supporting element 13 can also be made from other materials such as Teflon®, polyethylene (PE), perfluoroalkoxy (PFA), polytetrafluoroethylene (PTFE), polypropylene (PP) or other plastic polymers. It will be appreciated that a cross-section of the reactor means a “slice” of reactor at some location between the inlet and the outlet and as such, a slice of reactor can be generally orthogonal to the axis defined by the inlet and the outlet. A membrane covering a complete cross-section of the reactor would not allow raw liquid to pass from the inlet to the outlet without traversing the membrane and would therefore capture all possible “channels” from the inlet to the outlet at one particular location.

It will be appreciated that, in some embodiments such as that shown in FIG. 3, a controller 23 receives information from sensors about certain parameters/characteristics of the raw liquid (e.g. flow sensor 25 at liquid outlet 14) and adapts treatment accordingly. For example, a higher bacterial concentration or a specific bacteria type can be treated more effectively by adapting the flow rate of liquid into and out of the reactor or by creating a more active “suspension”. Other types of information that can be provided by sensors include, but are not limited to pH, TSS (total suspended solids), volume to be treated, redox potential. Upon processing input received from the sensors, the controller/processor can adapt treatment, such as controlling the flow rate of liquid into the reactor using a valve 19, the forcefulness of suspension of the antimicrobial medium, the residence time or temperature inside the reactor, etc. For example, if the controller 23 receives information from the reactor 10 that a flow rate determined by a flow sensor 25 in the liquid outlet 14 not be sufficient for keeping a desired level of expansion of the antimicrobial medium 16 in the reactor, an alarm 21 can be activated in order to alert an operator or to automatically initiate a response, such as the adjustment of valve 19 for controlling flow rate into the reactor in a desired predetermined range. It will be appreciated that if the desired level of expansion is achieved, the level of activity of the medium may be insufficient to kill/neutralize the microorganisms.

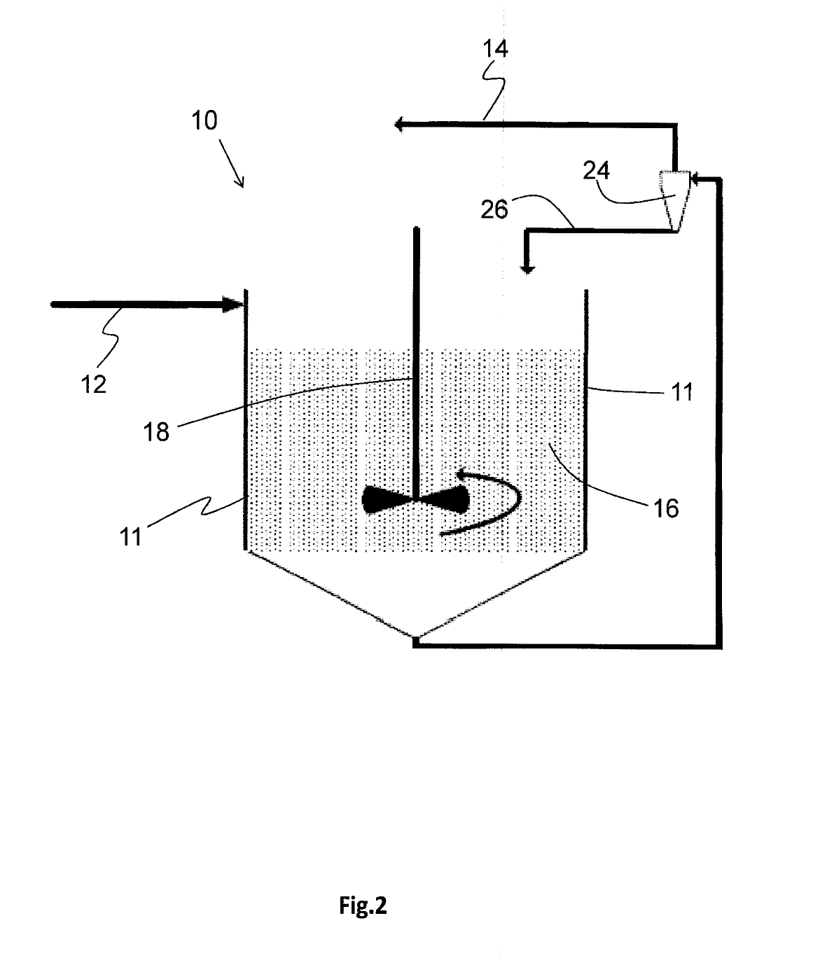

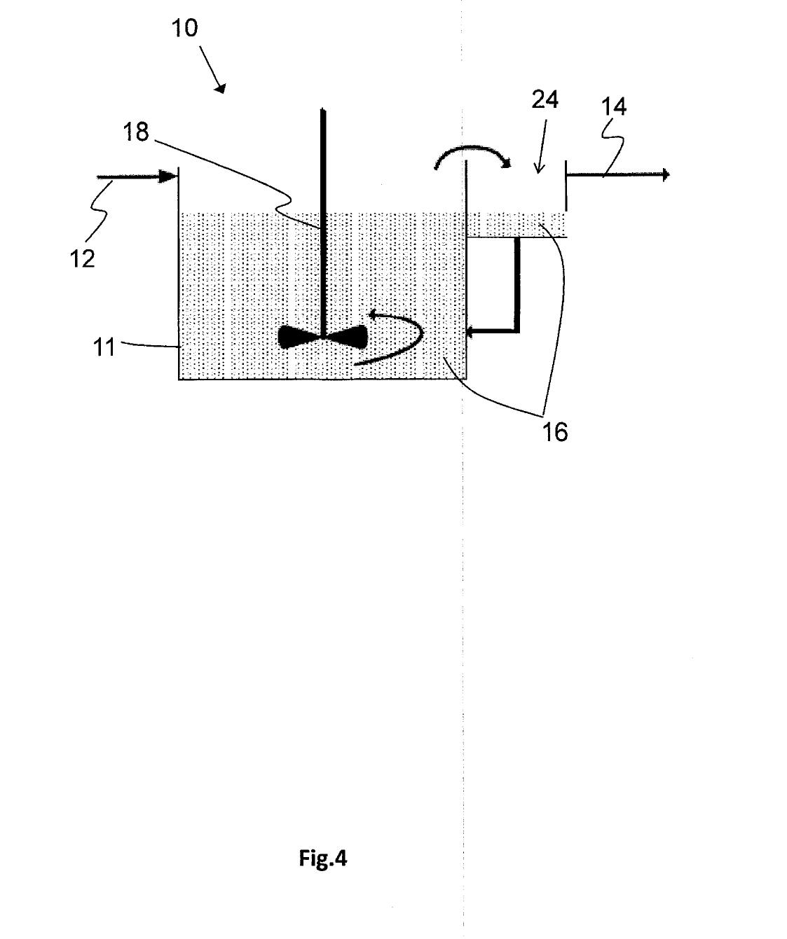

According to another embodiment and referring now to FIGS. 2 and 4, the reactor 10 may further includes an agitator 18 in the tank 11. In operation of the reactor 10, the agitator 18 agitates the raw liquid flow entered in the tank 11 by the raw liquid inlet 12 and the antimicrobial medium 16. This addition of the agitator 18 in the tank 11 induces the antimicrobial medium 16 to be in suspension in the tank 11 via a mechanical agitation process. Other suitable mechanical processes may be utilized in this case.

The antimicrobial medium 16 in the tank 11 of the reactor 10 comprises a media coated with an antimicrobial compound. The media may be, without limitation, sand particles, anthracite particles, gravel particles, activated carbon particles, zeolite particles, clay particles, diatomaceous earth particles, garnet particles, ilmenite particles, zircon particles, charcoal particles, ion exchange resin particles, silica gel particles, titania particles, black carbon particles, PVC, glass, glass, polymeric particles, plastic particles, organic particles and any suitable particles capable of being coated. The antimicrobial compound coating the media may be, without limitation, a zerovalent metal compound, an iron compound, a cast iron compound, a high purity iron compound, an iron sponge compound, iron powder, an aluminum compound, a ferrous sulfate compound, a ferric chloride compound, an aluminum sulfate compound, a quaternary ammonium salt compound, an organosilane quaternary compound, a quaternary ammonium compound, an oxidizing agent, a chelating agent, a surfactant, a wetting agent, an antibiotic compound, an antifungal agent, an antiviral agent, a silver compound, a copper compound, a zinc compound, a zero-valent silver compound, a zero-valent copper compound, a zero-valent zinc compound, a copper sulfate compound and any suitable combination. It is to be noted that the media (i.e., the sand particles) need to be very small for increasing the possible surface of contact of the antimicrobial medium 16 which will come into contact with the raw liquid flow.

According to another embodiment and referring now to FIGS. 1, 3, 5, 6 and 7, the tank 11 of the reactor 10 is a closed tank 11.

According to another embodiment and referring now to FIGS. 2 and 4, the tank 11 of the reactor is an opened tank 11. It is to be noted that the curved arrow presented on FIG. 4 between the tank 11 and the secondary tank 24 illustrates the flow consisting of water and antimicrobial medium that can be transported from the tank 11 and the secondary tank 24. This configuration of the tank 11 and the secondary tank 24 may provide for a better separation process.

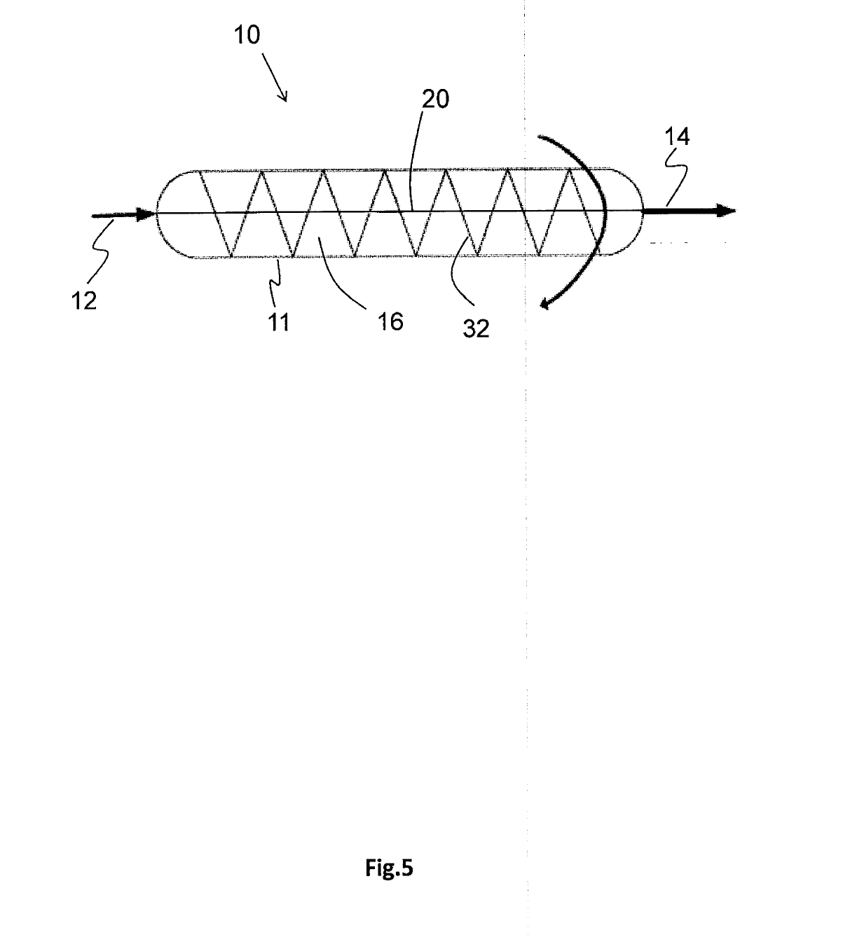

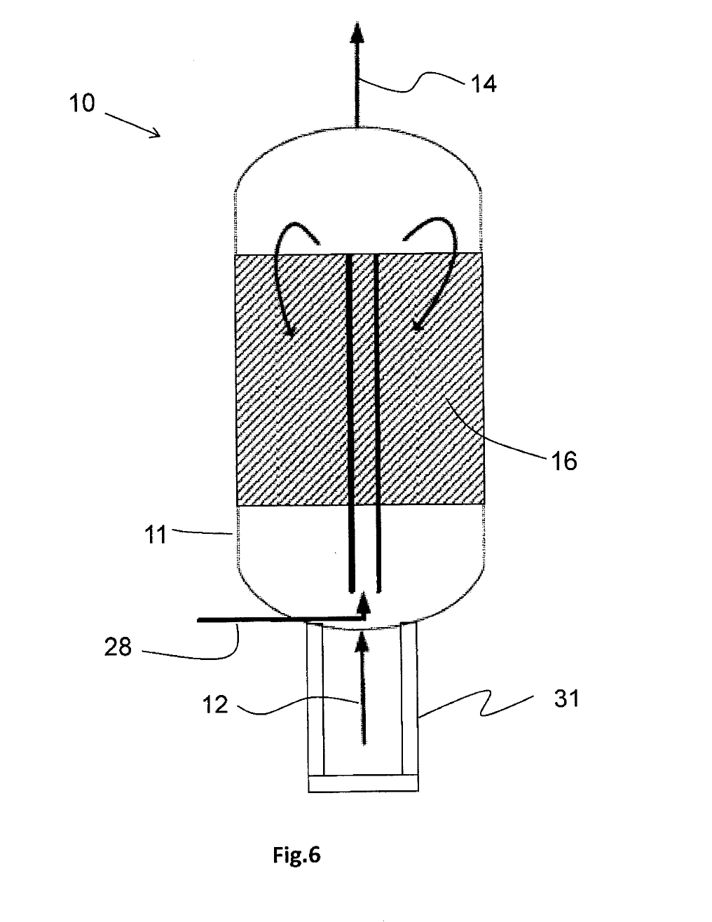

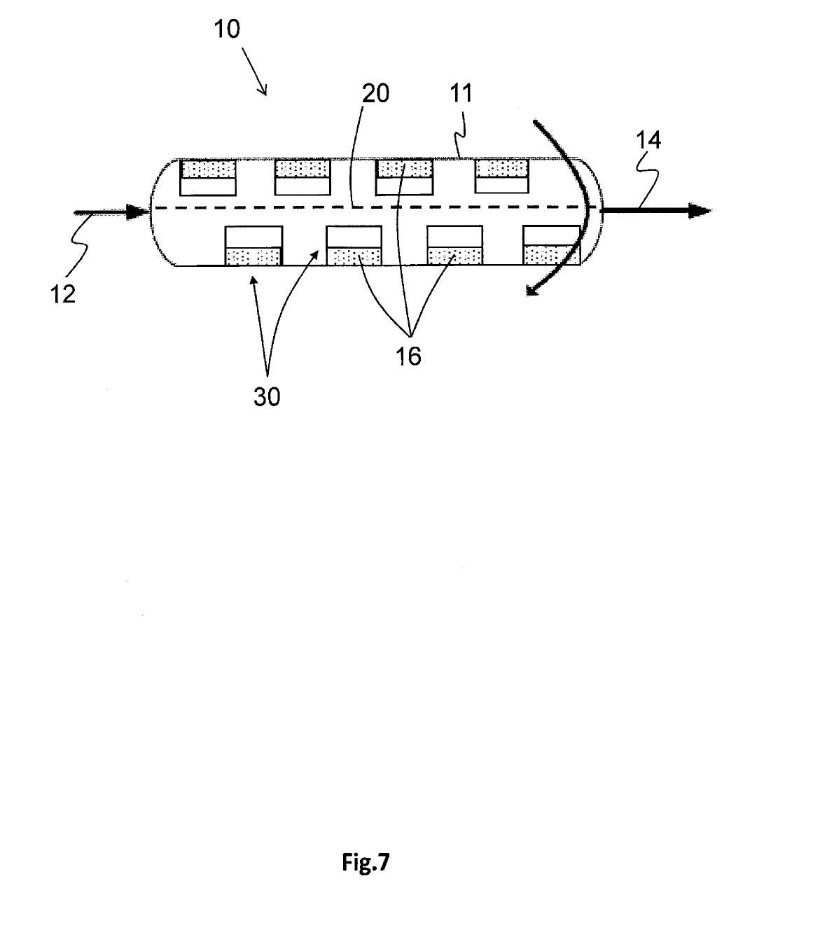

According to another embodiment, the tank 11 of the reactor 10 may define, without limitation, one of a longitudinal horizontal axis and a longitudinal vertical axis. For example, FIGS. 1, 2, 3, 4 and 6 define a tank 11 of the reactor 10 with a longitudinal vertical axis 22. However, FIGS. 5 and 7 define a tank 11 of the reactor 10 with a longitudinal horizontal axis 20. Additionally, the tank 11 of the reactor 10 may include, without limitation, one of a conical shape (FIGS. 1 and 2), a cylindrical shape (FIGS. 2, 3, 4, 5, 6 and 7), a square shape, a polygonal shape, a spherical shape (bottom and top of the tank 11 of FIGS. 3 and 6; left side and right side of the tank 11 of FIGS. 5 and 6) and any other suitable combination.

According to another embodiment and referring now to FIGS. 2 and 4, the reactor 10 may further includes a secondary tank 24 which allows a separation process occurring between the antimicrobial medium 16 and the disinfected liquid flow (not shown) (i.e., a flow of antimicrobial medium mixed with a flow of disinfected liquid enters the secondary tank 24 and a flow of antimicrobial medium exits the secondary tank 24 to possibly enter the tank 11+a flow of disinfected liquid exits the secondary tank 24). Thus, the reactor 10 as described above may further include a secondary antimicrobial medium inlet 26 which allows an antimicrobial medium flow (not shown) to enter the tank 11 (i.e., this secondary antimicrobial medium inlet 26 allows for recuperation of the antimicrobial medium 16).

According to another embodiment and referring now to FIGS. 5 and 7, the tank 11 of the reactor 10 may be a rotatable tank 11. According to this embodiment, in operation, the rotatable tank 11 is capable of rotating about the longitudinal horizontal axis 20 which allows the antimicrobial medium 16 to be in suspension in the tank 11 of the reactor 10. It is to be noted that the reactor 10 as shown in FIG. 5 includes a worm drive 32 for allowing the displacement of the antimicrobial medium 16 in the tank 11 of the reactor 10.

According to another embodiment and referring now to FIG. 6, the reactor 10 further includes an air inlet 28 at the bottom of the tank 11. The air inlet 28 allows an air stream to enter the tank 11 when the reactor 10 is in operation. The addition of the air inlet 28 on the tank 11 allows the antimicrobial medium 16 to be in suspension in the tank 11. The reactor 10 further comprises a base 31 which allows the reactor to have a longitudinal axis that is vertical in the embodiment of FIG. 6 but horizontal (not shown) in the case of FIG. 7.

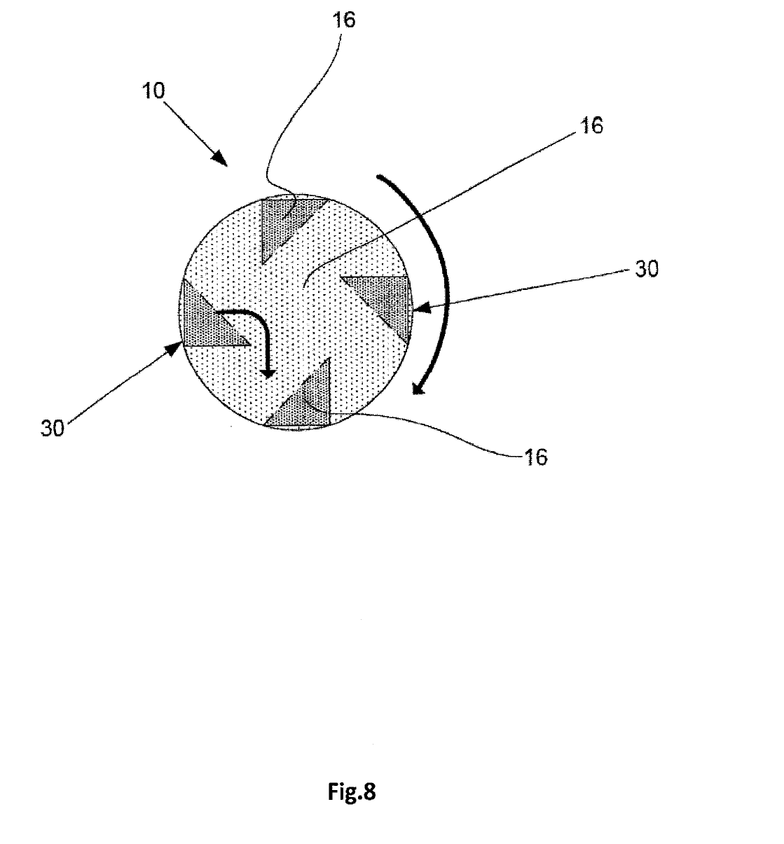

According to another embodiment and referring now to FIGS. 7-8, the reactor 10 further includes a plurality of compartments 30 in the tank 11 for receiving the antimicrobial medium 16. In the reactor 10 shown in FIGS. 7-8, the configuration of the tank 11 and its plurality of compartments 30 allow the antimicrobial medium 16 to be in displacement and therefore improve the surface contact between the raw liquid flow in the tank 11 to be disinfected and the antimicrobial medium 16.

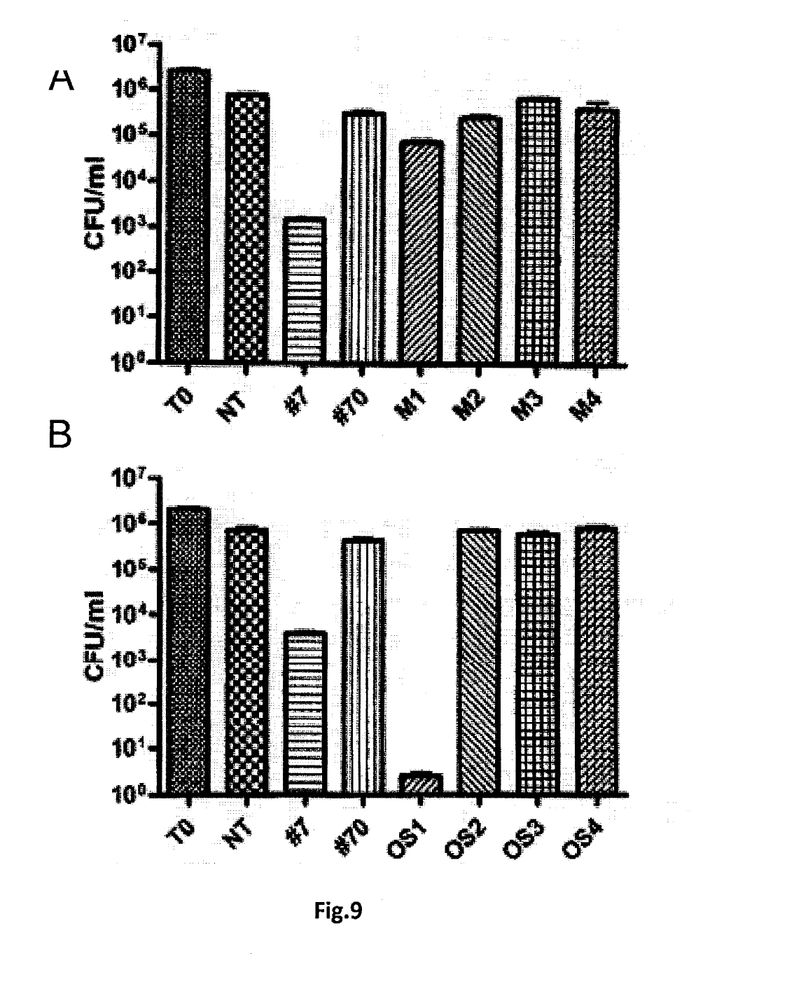

FIG. 9 shows the number of living bacteria (as evaluated by the number of CFUs/ml) which is indicative of the antibacterial activity of the various mineral and organic coatings tested. The objective of this set of experiments was to identify antibacterial coatings that performed well in “suspension” as opposed to immobilized coatings in a sand filtering apparatus, for example. Antimicrobial performance in suspension could not be predicted based on known antimicrobial activity of the immobilized coatings. The “T0” column of FIGS. 9A and 9B represents the initial microbial activity (CFUs/ml) before contacting any coated antimicrobial material (in this case, sand). NT is the “Non-Treated” negative control where the material was not coated with any antimicrobial product prior to contacting with the bacterial solution. #7 and #70 are positive controls known in the art to provide antimicrobial activity. M1 to M4 (FIG. 9A) and OS1 to OS4 (FIG. 9B) are various types of mineral/metal coatings and organosilane coatings, respectively. OS1 is octadecyldimethyl (trimethoxysilylpropyl)ammonium chloride (C₂₆H₅₈CINO₃Si) and is also identified as octadecyl TMACl or CAS# 27668-52-6. OS2 is the second organosilane molecule TMABr; OS3 is TMACl; and OS4 is polyethylene Imine. M1 comprises a Silver-based antimicrobial; M2 comprises a Copper-based antimicrobial; M3 comprises a Zinc-based antimicrobial; and M4 comprises a Copper and Zinc based antimicrobial.

In the experiments shown in FIG. 9, the strain of bacteria used was E. coli O157:H7 EDL933. 2 grams of antimicrobial medium was incubated in 2 ml solution for 10 minutes at 400 rpm on an orbital shaker. The liquid portion was then extracted to a agar plate, incubated at 37C for a predetermined period and the CFUs counted. None of the metal/mineral based antimicrobial coating (M1 to M4) showed a significant commercially viable antimicrobial effect under the conditions tested. As seen in FIG. 9B, one of the organic coatings (OS1) provided a very significant antimicrobial effect that was more potent than all the others, including the positive controls (#7 and #70).

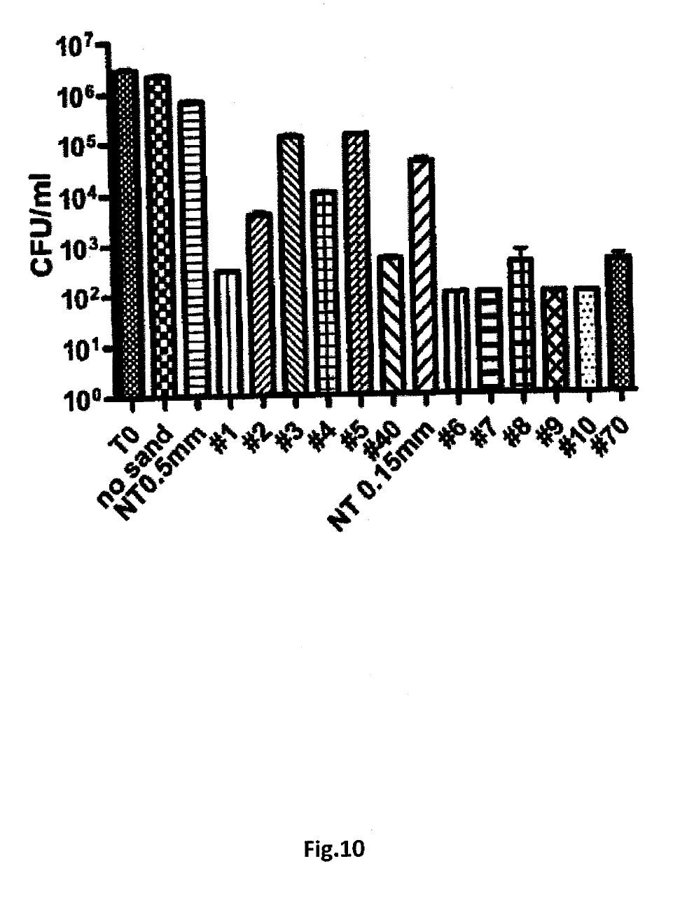

Antimicrobial medium was initially prepared by mixing sand particles of varying diameter with antimicrobial solutions at different concentrations. FIG. 10 shows antimicrobial activity of various OS1-coated sand particles of 0.5 mm and 0.15 mm on ATCC8739 strain of E. coli. Samples with different coating concentrations of organosilanes were tested in order to determine optimal ranges. For example, in samples #1-5, the OS1 antimicrobial solution (at 5% dilution) was used at a concentration of 250, 125, 90, 70 and 52.5 ml of organosilane solution per kg of 0.5 mm sand, respectively. In samples #6-10, the antimicrobial solution (at 5% dilution) was used at a concentration of 330, 160, 115, 87.5 and 62.5 ml of organosilane solution per kg of 0.15 mm sand, respectively.

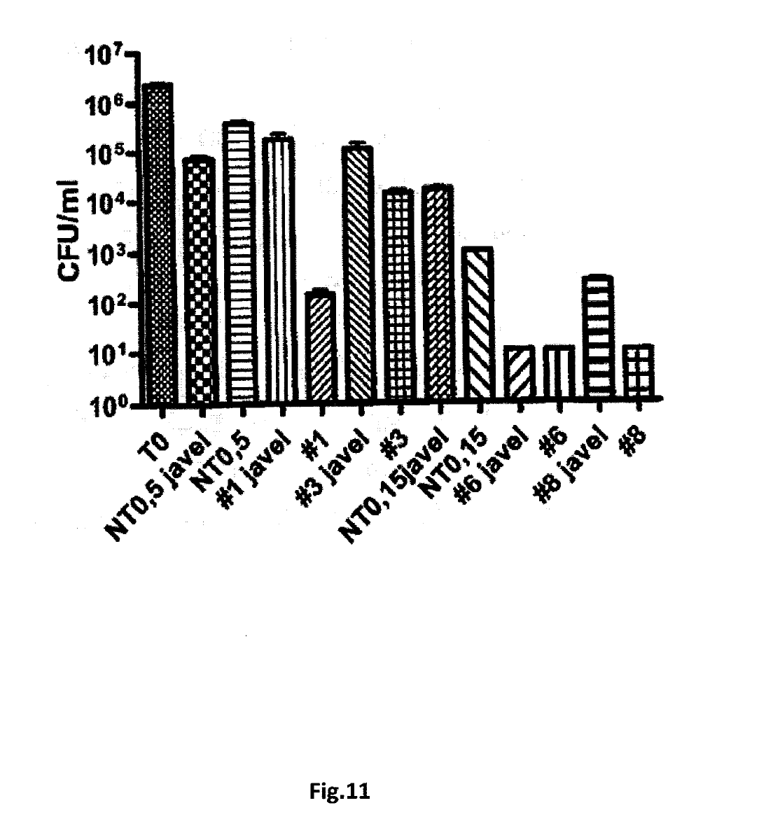

In the experiments shown in FIG. 11, 2 grams of antimicrobial medium (coated sand was incubated in 2 ml solution for 30 minutes at 400 rpm on an orbital shaker. The liquid portion was then extracted to an agar plate, incubated at 37C for a predetermined period and the CFUs counted. Samples #40 and #70 are positive controls using antimicrobial coatings known to be effective in immobilized conditions. Results showed that for all coating densities, the sand particles of 0.15 mm had better antimicrobial activity than those of 0.5 mm. Samples #6 and #7 were the most promising because they achieved an antimicrobial activity similar to samples #8 and #9 which have higher coating densities.

Further testing was therefore performed on the OS1 coating of sand having particle sizes of 0.5 mm (#1 and #3) and 0.15 mm (#6 and #8) using the ATCC8739 strain of E. coli. FIG. 11 shows the resistance of various concentrations of the OS1 coating to a 20 hour bleach/sodium hypochlorite (0.1%) pre-treatment. In the experiments shown in FIG. 10, the 2 grams of the antimicrobial medium (coated sand) was incubated in 2 ml solution for 30 minutes at 400 rpm on an orbital shaker. The liquid portion was then extracted to an agar plate, incubated at 37C for a predetermined period and the CFUs counted. Results show that bleach pre-treatment was able to “destroy” antimicrobial activity of certain samples, most likely by oxidative processes. For example, although sample #1 showed very interesting antimicrobial activity, bleach pre-treatment essentially eliminated its subsequent antimicrobial activity, making the efficacy of sample #1 doubtful for applications in oxidizing environments. On the other hand, the antimicrobial activity of sample #6 was not affected by bleach pre-treatment, suggesting interesting characteristics for this sample. The other samples tested (#3 and #8) showed a decrease in ant-microbial activity following bleach pretreatment

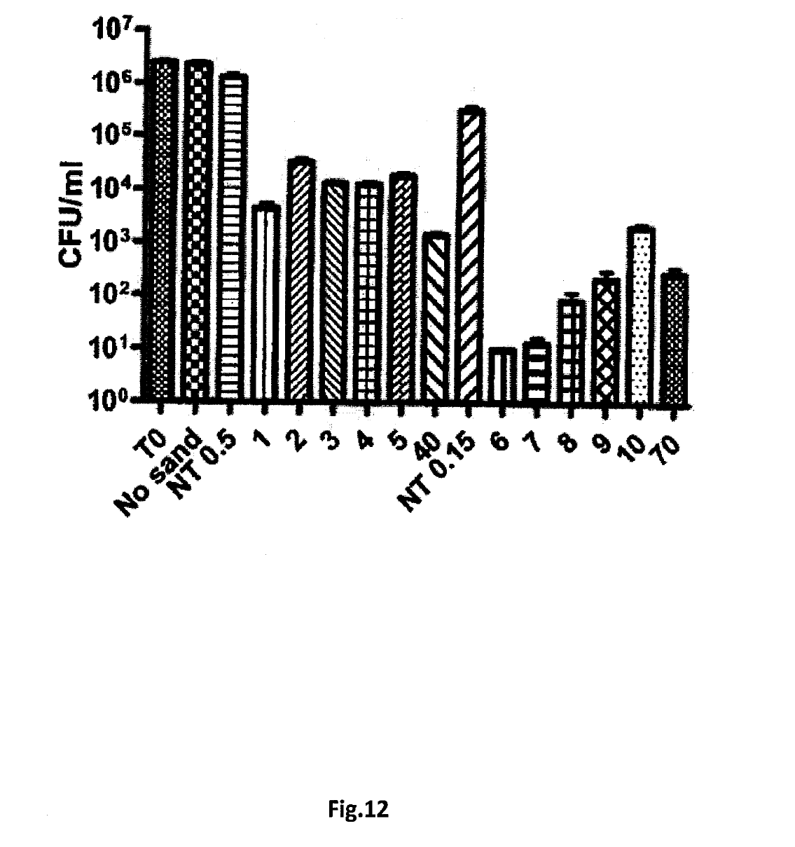

FIG. 12 shows antimicrobial activity of various OS1-coated sand particles of 0.5 mm and 0.15 mm on O157:H7 EDL933 strain of E. coli. Samples with different coating densities of organosilanes were tested in order to determine optimal coating density ranges. In the experiments shown in FIG. 12, 2 grams of antimicrobial medium (coated sand) was incubated in 2 ml solution for 30 minutes at 400 rpm on an orbital shaker. The liquid portion was then extracted to an agar plate, incubated at 37C for a predetermined period and the CFUs counted. Samples #40 and #70 are positive controls using antimicrobial coatings known to be effective in immobilized conditions. Results showed that for all coating densities, the sand particles of 0.15 mm had better antimicrobial activity than those of 0.5 mm. Sample #7 was promising because it achieved antimicrobial activity similar to sample #6 with a 50% lower concentration of antimicrobial. Samples #8-10 showed a concentration dependent decrease in antimicrobial activity.

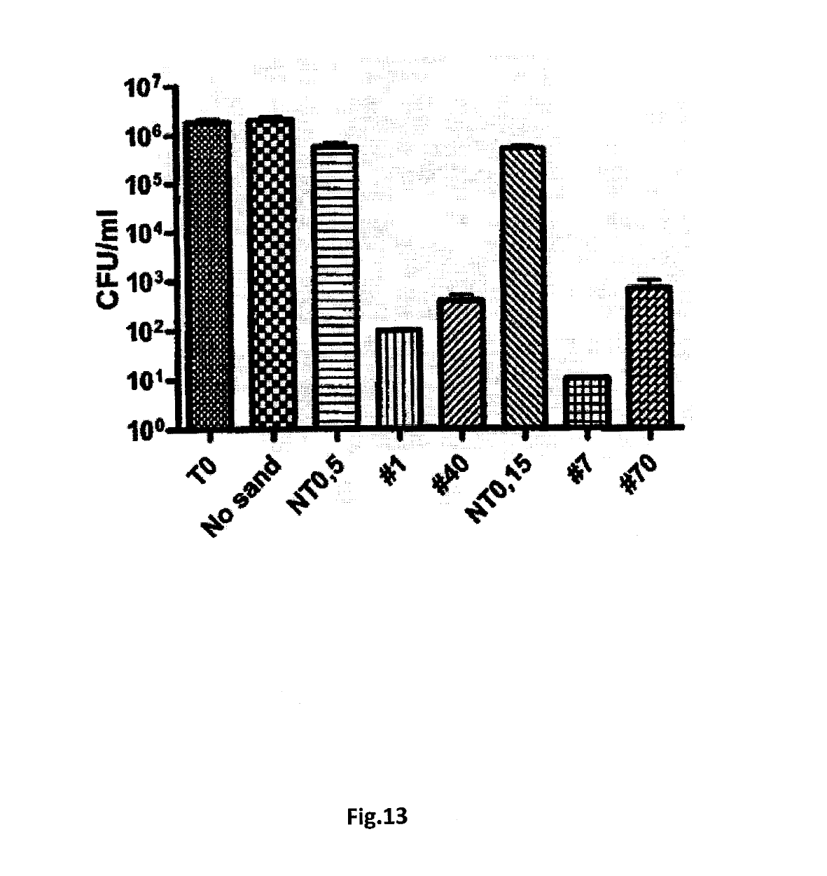

FIG. 13 shows antimicrobial activity of various OS1-coated sand particles of 0.5 mm and 0.15 mm on Legionella pneumophila. Samples with different coating densities of organosilanes were tested in order to determine optimal coating density ranges. In the experiments shown in FIG. 12, 2 grams of antimicrobial medium (coated sand) was incubated in 2 ml solution for 30 minutes at 400 rpm on an orbital shaker. The liquid portion was then extracted to an agar plate, incubated at 37C for a predetermined period and the CFUs counted. Samples #40 and #70 are positive controls using antimicrobial coatings known to be effective in immobilized conditions. Results showed that sample 7 (sand particles of 0.15 mm) had better antimicrobial activity than sample #1 (sand particles of 0.5 mm).

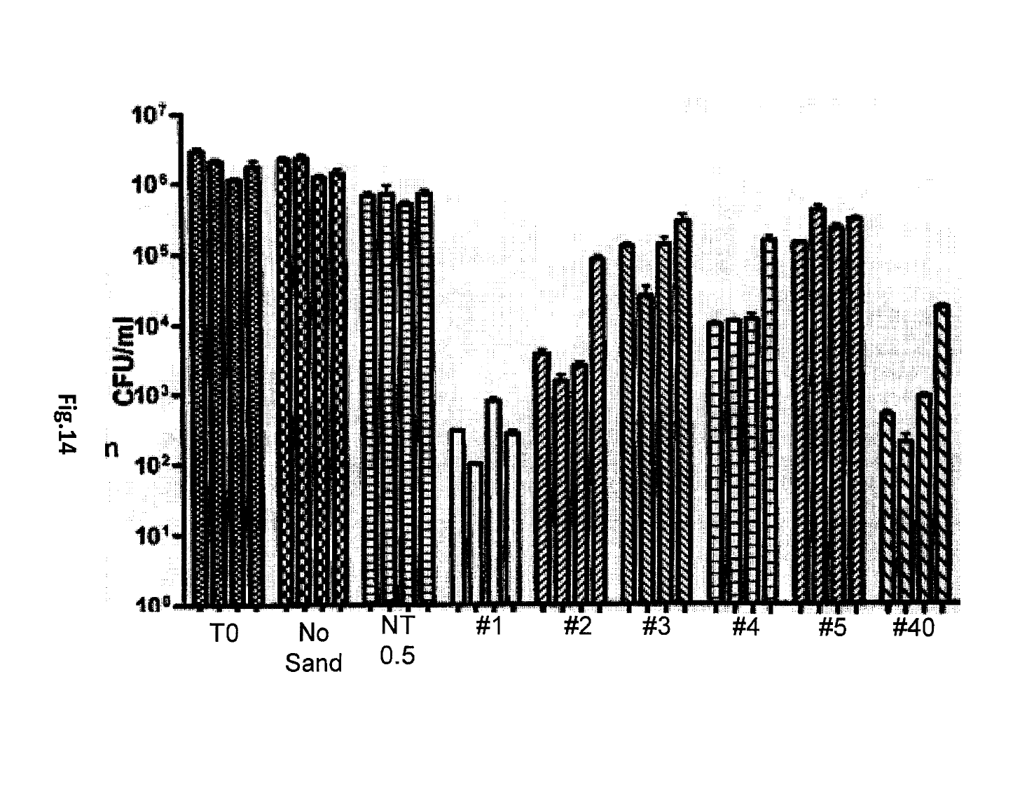

FIG. 14 shows results obtained with coated sand samples exposed for various times to the bacterial solution containing the ATCC8739 strain of E. coli. The first column for each set represents a contact time of 1 hour, the second column is a 30 minute contact time, the third column is a 15 minute contact time and the fourth column is a 5 minute contact time. FIG. 14 shows antimicrobial activity of various OS1-coated sand particles (0.5 mm) using the ATCC8739 strain of E. coli. Samples with different coating densities and contact times were tested in order to determine optimal ranges for coating density and contact times. In the experiments shown in FIG. 14, 2 grams of sand were coated with the various antimicrobial material and incubated in 2 ml solution for 30 minutes at 400 rpm on an orbital shaker. The liquid portion was then extracted to an agar plate, incubated at 37C for a predetermined period and the CFUs counted. Samples “No Sand” and “NT” (non-treated/coated sand) were negative controls while sample #40 was a positive control using antimicrobial coatings known to be effective in immobilized conditions. Results showed that sample #1 had the best antimicrobial activity of all samples tested.

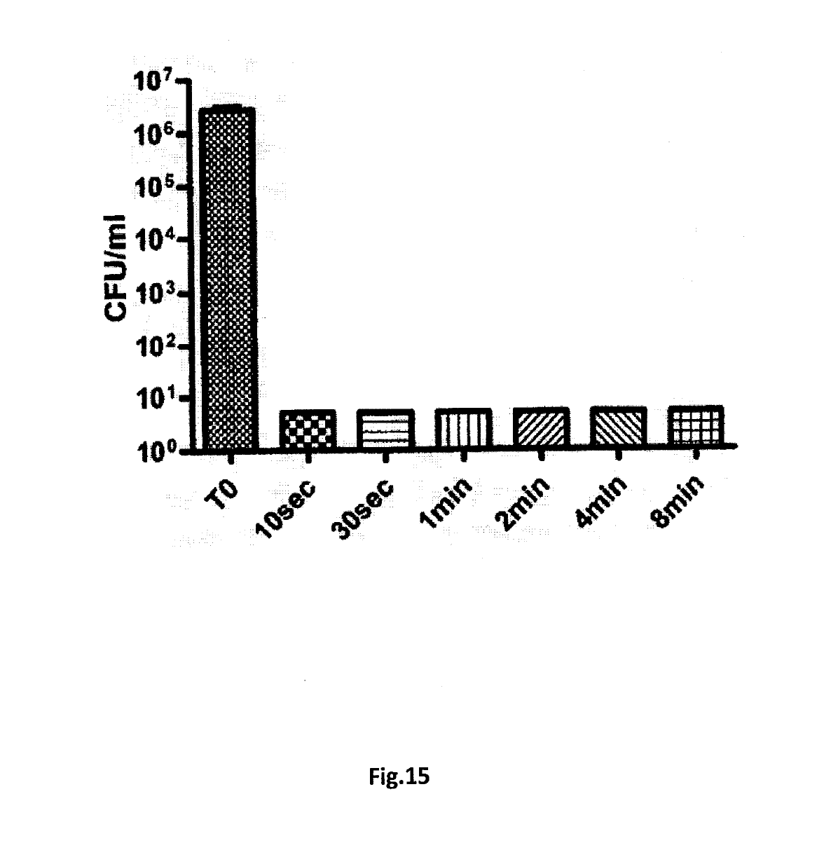

FIG. 15 is a graph of bacterial (E. coli—O157:H7 EDL933) activity as a function of various incubation times (between 10 seconds and 8 minutes) with antimicrobial medium (coated sand—OS1) having a 0.5 mm average particle size. In the experimental protocol, although a 1:1 ratio was maintained, a larger quantity of antimicrobial medium (250 g) and a larger volume of solution (250 ml) were used as compared to other protocols using mainly a 2 ml solution. The objective was to perform a time-course analysis in a range less than 5 minutes because the majority of the antibacterial effect was already observed after a 5 minute contact time, as shown in FIG. 14. In conclusion, because even the shortest contact time of 10 seconds showed a decrease in bacterial CFUs from more than 10⁶ CFUs/ml to less than 10¹ CFUs/ml, these results suggest that in the experimental conditions tested (higher volume and coated sand quantity), the time-course analysis will have to use smaller contact times. Furthermore, because the antibacterial effect of the OS1-coated sand particles is significantly increased by an increased volume and quantity of sand, it is therefore possible that further increasing from bench scale to industrial scale may provide even better results than those observed herein.

It will be understood that the microbial portion of the term antimicrobial includes all types of microbes/microorganisms such as bacteria, virus, fungi, mold, algae, yeast, protozoa. Thus, in some embodiments, the antimicrobial medium is an antibacterial medium.

It will be understood that operation of a reactor according to the present invention means treatment of raw liquid to decrease the number of viable microorganisms from the raw liquid while an antimicrobial medium is in suspension in the reactor.

It will be understood that putting the antimicrobial medium into suspension inside the reactor using the suspension device creates a cloud of particles that contacts microorganisms as they pass from the inlet to the outlet. Several factors can affect the number of efficient contacts between particles and microorganisms. An efficient contact is understood to be a contact that will result in killing a microorganism, such as a bacteria. The mechanism by which antimicrobial compounds, such as organosilane compounds kill microorganisms is known in the art when coating immobilized media or surfaces, however, the efficiency and action of organosilane compounds in a dynamic environment were not known.

The flow of liquid entering the reactor from a liquid inlet at the bottom of the reactor acts as a “suspension device” and can determine the efficiency of killing. For example, a high flow will cause a greater expansion of the antimicrobial medium and therefore a lower density such that efficient contacts may decrease. In addition, when no media barrier 15 is present, a very high flow rate may cause a rapid loss of antimicrobial particles from the reactor.

The size, sphericity and roundness of the particles will also affect the ability of a predetermined inflow to cause an expansion of the antimicrobial medium. It is understood that a greater flow is required to expand highly spherical and round particles due to the lower friction from the particles.

It will be appreciated that, when the reactor is shaped as an Imhoff cone and has a liquid inlet at the bottom of the reactor, a uniform suspension will be observed at each cross-section of the cone/reactor along its longitudinal axis (a vertical axis in this embodiment). However, a cross-section closer to the bottom of the cone/reactor may provide a level of suspension (i.e. activity, motion, energy) of the antimicrobial medium that is more or less dynamic than a level of suspension at a cross-section that is at a higher location of the cone/reactor. Overall however, the average number of effective contacts between antimicrobial medium and microorganism will nevertheless be similar.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A reactor for disinfecting a liquid comprising:
a raw liquid inlet for allowing a raw liquid to enter the reactor;
a disinfected liquid outlet for releasing a disinfected liquid from the reactor;
a suspension device for creating a highly dynamic suspension of an antimicrobial medium in a cross-section of the reactor through which the raw liquid passes to insure a substantially uniform, high average number of interactions between the antimicrobial medium and microorganisms present in the liquid, thereby decreasing a quantity of viable microorganisms in the liquid as it passes from the inlet to the outlet; and
an inlet nozzle connected to the raw liquid inlet, said nozzle being located below the disinfected liquid outlet, such that an upstream flow in the reactor causes the antimicrobial medium to be in suspension in the reactor during operation.

2. (canceled)

3. The reactor of claim 1, wherein the suspension device further comprises an agitator in the reactor, wherein in operation, the agitator agitates the antimicrobial medium and raw liquid entering into the reactor.

4. The reactor of claim 1, wherein the suspension device further comprises an air inlet for injecting an air stream into the reactor, thereby allowing the antimicrobial medium to be in suspension in the reactor during operation.

5. The reactor of claim 1, further comprising a filtering device for separating the antimicrobial medium from the liquid.

6. The reactor of claim 5, wherein the filtering device comprises one or more of a nylon membrane and a wedgewire.

7. The reactor of claim 1, further comprising a quantity of said antimicrobial medium, wherein the antimicrobial medium comprises a media coated with an antimicrobial compound.

8. The reactor of claim 7, wherein the media comprises one or any combination of sand particles, anthracite, gravel, activated carbon, zeolite, clay, diatomaceous earth, garnet, ilmenite, zircon, charcoal, ion exchange resin, silica gel, titania, black carbon, PVC, glass, glass, polymeric particles, plastic particles, organic particles.

9. The reactor of claim 8, wherein the media comprises sand particles having an average particle size between 0.01 mm and 1.0 mm.

10. The reactor of claim 8, wherein the media comprises sand particles having an average particle size of approximately 0.15 mm.

11. The reactor of claim 7, wherein the antimicrobial compound comprises one or any combination of a zero-valent metal compound, an iron compound, a cast iron compound, a high purity iron compound, an iron sponge compound, iron powder, an aluminum compound, a ferrous sulfate compound, a ferric chloride compound, an aluminum sulfate compound, a quaternary ammonium salt compound, a quaternary ammonium compound, an oxidizing agent, a chelating agent, a surfactant, a wetting agent, an antibiotic compound, an antifungal agent, an antiviral agent, a silver compound, a copper compound, a zinc compound, a zero-valent silver compound, a zero-valent copper compound, a zero-valent zinc compound, a copper sulfate compound.

12. The reactor of claim 7, wherein said antimicrobial compound comprises a quaternary organosilane.

13. The reactor of claim 12, wherein said quaternary organosilane compound is octadecyldimethyl(trimethoxysilylpropyl)ammonium chloride.

14. The reactor of claim 13, wherein said antimicrobial medium comprises media coated with a concentration between 0.1 to 1000 moles of compound per kilogram of media.

15. The reactor of claim 13, wherein said antimicrobial medium comprises media coated with a concentration of approximately 15 moles of compound per kilogram of media.

16. The reactor of claim 1, further comprising a quantity of said antimicrobial medium, wherein said antimicrobial medium is resistant to a 20 hour 0.1% bleach pre-treatment.

17. The reactor of claim 1, further comprising a quantity of said antimicrobial medium, wherein said antimicrobial medium is effective at killing one or more of the bacterial strains E. coli ATCC8739, E. coli O157:H7 EDL933 and Legionella pneumophila.

18. The reactor of claim 1, further comprising a base configured to support said reactor such that a longitudinal axis of the reactor is one of a horizontal axis and a vertical axis.

19. The reactor of claim 1, wherein a shape of the reactor comprises one or any combination of: a conical shape, a cylindrical shape, a square shape, a polygonal shape, a spherical shape.

20. The reactor of claim 1, further comprising a secondary tank for allowing a separation between the antimicrobial medium and the disinfected liquid flow.

21. The reactor of claim 1, further comprising a secondary antimicrobial medium inlet for allowing an antimicrobial medium to enter the reactor.

22. The reactor of claim 1, further comprising bearings for rotating the reactor such that, in operation, the reactor rotates about the longitudinal axis, allowing the antimicrobial medium to be in suspension in the reactor.

23. The reactor of claim 1, further comprising a plurality of compartments for receiving the antimicrobial medium therein.

24. The reactor of claim 1, wherein the suspension device causes an expansion of the antimicrobial medium by between 10% and 80% as compared to when the suspension device is inactive.

25. The reactor of claim 1, wherein the suspension device causes an expansion of the antimicrobial medium by approximately 50% as compared to when the suspension device is inactive.

26. The reactor of claim 1, wherein a flow rate of 15 m3 of liquid per m2 of surface area per hour maintains a 50% expansion of the antimicrobial medium of inside the reactor as compared to when a flow rate is zero.

27. The reactor of claim 1, further comprising at least one of a flow sensor and an expansion sensor that send data to a controller for triggering at least one of an alarm and a flow adjustor when a detected flow rate or a level of expansion of said antimicrobials media is out of a predetermined range for creating a level of expansion of said antimicrobial medium inside said reactor.

28. A cooling tower combined with a reactor of claim 1, wherein said liquid is from the cooling tower.

29-44. (canceled)
